(19) United States
(12) Patent Application Publication
(10) Pub. No.: US 2026/0121768 A1
(43) Pub. Date: Apr. 30, 2026

(54) UNDERWATER RADIO FREQUENCY COMMUNICATION AND IMAGING THROUGH SURFACE ELECTROMAGNETIC WAVES

(71) Applicant: Saltenna Inc., Mclean, VA (US)

(72) Inventors: Igor SMOLYANINOV, Columbia, MD (US); Quirino BALZANO, Annapolis, MD (US); Mark BARRY, Washington, DC (US); Dendy YOUNG, Delaplane, VA (US)

(21) Appl. No.: 19/149,319

(22) PCT Filed: Oct. 28, 2024
(86) PCT No.: PCT/US2024/053269

§ 371 Date: Jul. 18, 2025

Related U.S. Application Data
(60) Provisional application No. 63/593,468, filed on Oct. 26, 2023.

(51) Int. Cl. H04B 13/02; H01Q 21/06

(52) U.S. Cl. CPC H04B 13/02; H01Q 21/06

(57) ABSTRACT

Methods, systems, and devices for underwater communication are described. In some examples, a communication system may comprise a transmitter configured to excite surface electromagnetic waves along a water surface, utilizing the water surface as a superlens to focus the intensity of the excited surface electromagnetic waves from an object plane of the transmitter through the water surface. The transmitter may be further configured to communicatively couple with a receiver that may be configured to detect the surface electromagnetic waves propagated from the transmitter across the water surface. Some implementations enable efficient underwater radio communication and imaging over significant distances, leveraging the superlensing effect of surface electromagnetic waves for enhanced signal propagation and reception.

### CROSS REFERENCE TO RELATED APPLICATIONS

The present Application for patent claims the benefit of U.S. Provisional Application No. 63/593,468, filed Oct. 26, 2023, entitled “UNDERWATER METHOD AND SYSTEM UTILIZING SUPERLENSING-BASED RADIO COMMUNICATION AND IMAGING,” assigned to the assignee hereof, and which is hereby incorporated by reference in its entirety.

### FIELD OF TECHNOLOGY

The present disclosure relates generally to communication systems, and more specifically to enabling underwater radio frequency communication and imaging through surface electromagnetic waves.

### BACKGROUND

In the field of underwater exploration and communication, various technologies may be utilized to facilitate the transmission of information and the capture of images beneath the water's surface. These technologies may include systems that operate based on acoustic signals, which may traverse long distances underwater, and optical systems, which may offer higher bandwidth capabilities. The interface between water and air may present a significant boundary for radio frequency signals.

### SUMMARY

The described implementations relate to improved communication systems and associated methods for enabling underwater radio frequency communication and imaging through surface electromagnetic waves. In some examples, a method and system for underwater radio frequency communication and imaging may leverage the concept of superlensing through surface electromagnetic waves. This approach may utilize the water surface as a superlens, enabling the propagation of radio frequency signals underwater with significantly improved range and resolution compared to traditional methods. The system may comprise specialized antennas designed to couple with surface electromagnetic waves, which are matched to the dispersion law of these waves. These antennas may be capable of exciting or detecting the surface electromagnetic waves, facilitating efficient signal transmission and reception.

The antennas may be arranged to create directional beams, allowing for targeted communication and high-resolution imaging. This directional capability may be achieved through the use of antenna arrays, which can be configured to focus the radio frequency energy in specific directions, enhancing the system's effectiveness and reducing the likelihood of signal detection outside the intended area. By overcoming the limitations of acoustic and optical systems, and enabling efficient communication across the water-air interface, some implementations may open up new possibilities for underwater communication and imaging. They may offer a solution that is both high-bandwidth and discreet, with minimal impact on marine life, making it suitable for a wide range of applications including military, scientific, and commercial use.

A communication system for underwater use is described. The system may include a transmitter configured to excite surface electromagnetic waves along a water surface, wherein the water surface may be used as a superlens to focus an intensity of the excited surface electromagnetic waves from an object plane of the transmitter through the water surface. The transmitter may be configured to communicatively couple with a receiver configured to detect the surface electromagnetic waves propagated from the transmitter across the water surface.

A method for communicating underwater is described. The method may include exciting surface electromagnetic waves along a water surface with a transmitter. The method may use the water surface as a superlens to focus an intensity of the excited surface electromagnetic waves from an object plane of the transmitter through the water surface. The method may include communicatively coupling the transmitter with a receiver configured to detect the surface electromagnetic waves propagated from the transmitter across the water surface.

An apparatus for communicating underwater is described. The apparatus may include a means for exciting surface electromagnetic waves along a water surface with a transmitter. The apparatus may include a means for using the water surface as a superlens to focus an intensity of the excited surface electromagnetic waves from an object plane of the transmitter through the water surface. The apparatus may include a means for communicatively coupling the transmitter with a receiver configured to detect the surface electromagnetic waves propagated from the transmitter across the water surface.

Some examples of the technologies and related methods described herein may further include a transmitter antenna configured to match a field configuration of the surface electromagnetic waves for excitation along the water surface.

In some examples of the technologies and related methods described herein, the transmitter antenna may be configured to provide directional intensity for the excitation of the surface electromagnetic waves propagated from a transmitter.

In some examples of the technologies and related methods described herein, the transmitter antenna may include an array of antennas.

Some examples of the technologies and related methods described herein may further include a receiver antenna configured to match a field configuration of the surface electromagnetic waves for detection along the water surface.

In some examples of the technologies and related methods described herein, the receiver antenna array may be configured to provide directional sensitivity for the detection of the surface electromagnetic waves propagated from one or more transmitters.

In some examples of the technologies and related methods described herein, the receiver antenna may include an array of antennas.

In some examples of the technologies and related methods described herein, the transmitter may be configured to operate at a frequency range that allows for communication over distances of 100 or more skin depths in fresh water.

In some examples of the technologies and related methods described herein, the receiver may be configured to detect subwavelength super-resolution images of an object located below the water surface by analyzing the intensity of the received surface electromagnetic waves.

Some examples of the technologies and related methods described herein may further include a protective enclosure for one or both of the transmitter and the receiver. The protective enclosure may be configured to prevent short-circuiting when submerged in water.

In some examples of the technologies and related methods described herein, the water surface may act as a superlens to enhance the transmission of the surface electromagnetic waves from the object plane to the receiver.

In some examples of the technologies and related methods described herein, the transmitter may be configured to operate in seawater, enhancing the intensity of the surface electromagnetic waves for robust transmission.

In some examples of the technologies and related methods described herein, the receiver may be configured to detect changes in the intensity of the surface electromagnetic waves in response to an object interacting with a metal screen submerged in a pool.

### BRIEF DESCRIPTION OF THE DRAWINGS

FIG. 1 illustrates a system that demonstrates the concept of surface electromagnetic waves (SEWs), in accordance with one or more implementations.

FIG. 2 shows underwater radio communication which supports techniques for enabling underwater radio frequency communication and imaging through surface electromagnetic waves in accordance with various aspects of the present disclosure.

FIG. 3 shows a radio communication diagram which supports techniques for enabling underwater radio frequency communication and imaging through surface electromagnetic waves in accordance with various aspects of the present disclosure.

FIG. 4 shows a scatter plot illustrating the relationship in fresh water between communication distance and the sum of depths of two radios underwater in accordance with various aspects of the present disclosure.

FIG. 5 shows a scatter plot illustrating the relationship in pool water between communication distance and the sum of depths of two radios underwater in accordance with various aspects of the present disclosure.

FIG. 6 shows a scatter plot illustrating the power scaling of underwater radio communication experiments in accordance with various aspects of the present disclosure.

FIG. 7 shows a line graph illustrating the measured profile of the surface electromagnetic wave near the water surface at 30 MHz in accordance with various aspects of the present disclosure.

FIG. 8 shows superlens imaging transition which supports techniques for enabling underwater radio frequency communication and imaging through surface electromagnetic waves in accordance with various aspects of the present disclosure.

FIG. 9 shows underwater radio transmission which supports techniques for enabling underwater radio frequency communication and imaging through surface electromagnetic waves in accordance with various aspects of the present disclosure.

FIG. 10 shows a flowchart illustrating a method of using communication systems for enabling underwater radio frequency communication and imaging through surface electromagnetic waves in accordance with various aspects of the present disclosure.

### DETAILED DESCRIPTION

The described implementations relate to improved communication systems and associated methods for enabling underwater radio frequency communication and imaging through surface electromagnetic waves. In some examples, the limitations of existing underwater communication and imaging technologies may present several problems. Acoustic methods, while capable of long-range communication, may have limited data transmission capabilities and may disturb marine ecosystems. Optical methods may offer higher data rates but may be ineffective in turbid waters and over long distances. Additionally, both methods may be detectable over large areas, which can be undesirable for applications requiring privacy or stealth. The water-air interface further complicates matters, as traditional radio frequency communication methods may fail to penetrate this boundary efficiently, necessitating complex and often impractical solutions. These challenges may hinder the advancement of underwater exploration, the safety of sub-surface operations, and the development of new communication technologies for underwater environments.

According to some implementations, a system may utilize the superlensing effect of surface electromagnetic waves that travel along the water surface to enable radio frequency communication and imaging underwater. These waves may undergo exponential attenuation and recovery of electromagnetic fields during their propagation, which allows for the transmission of radio signals through water over distances much greater than what is typically possible with conventional radio communication channels.

In some implementations, the system may facilitate efficient radio communication over several hundred skin depths in the megahertz frequency range. This communication may be made possible by the coupling of radio signals to a mode of surface electromagnetic waves that move along the water surface. The system may include specialized antennas that are connected to radios, all of which are completely submerged underwater.

Some implementations may allow for subwavelength super-resolution radio imaging in the gigahertz range by using the water surface as a superlens. This capability may be demonstrated by the ability to produce images with a resolution greater than what conventional imaging methods would allow.

The antennas in some implementations may be designed to resonate with the surface electromagnetic waves and to match the field configuration of these waves, which includes both transverse and longitudinal components. The antennas may be designed to have a strong electric field at their tips to efficiently excite the longitudinal component of the surface electromagnetic waves. These antennas may be arranged in an array to create directional beams for communication or imaging purposes. They may be electrically isolated from the water to prevent shorting and impedance-matched to the water to ensure efficient signal transmission and reception.

Surface electromagnetic waves in some implementations may exhibit a propagation length that is significantly greater than the skin depth, allowing for extended communication distances along the water surface. These waves may be characterized by a wave vector that has both a component parallel to the water surface and a component perpendicular to it, which decays exponentially with distance from the surface.

Some implementations may enable direct radio communication through the water-air interface, which has historically been a challenging barrier for underwater communication. The surface electromagnetic waves may exist simultaneously in both water and air, allowing for efficient communication across the interface.

In some implementations, the power scaling of radio communication experiments may demonstrate that the communication distances scale linearly with the skin depth and that increasing transmit power leads to a proportional increase in communication distance. This behavior may indicate the surface electromagnetic wave-mediated signal transmission mechanism.

The system may have implications for bioimaging, as the human body itself may act as a superlens for radio waves, enabling high-resolution imaging through biological tissues. The system may offer a safe approach to wireless radio communication and imaging underwater, which is essential for ocean and seafloor exploration. The techniques developed may be used for studying extraterrestrial water worlds, such as potentially habitable moons of gas giants.

Compared to extremely low-frequency underwater communication systems, some implementations may provide a significant improvement in communication bandwidth. Unlike acoustic communication and imaging methods, the radio frequency-based system may not negatively affect marine life due to its relatively short-range and low power signals. The surface electromagnetic wave signals may not be affected by water turbidity, making the system suitable for murky water environments.

Some implementations may have been validated through underwater radio communication experiments performed using surface electromagnetic wave antennas in various water conditions, including freshwater, pool water, and seawater. The experiments may confirm the surface electromagnetic wave character of the radio communication links underwater and the ability to communicate over distances far beyond the conventional limit set by the skin depth.

Aspects of the subject matter described in this disclosure can be implemented to realize one or more of the following potential advantages. The described techniques may be implemented to support enhanced communication capabilities for divers and underwater vehicles, enabling them to transmit data and voice signals over significant distances without the need for wired connections. The system may provide a method for real-time monitoring of underwater environments, which may be critical for scientific research and environmental protection. The technology may offer a non-invasive approach to studying marine ecosystems, as it may not disturb the aquatic life with noise pollution commonly associated with acoustic methods. The described system may be adapted for emergency response scenarios, where rapid and reliable communication is essential for coordinating rescue operations. The ability to use the water surface as a superlens may open up new possibilities for medical diagnostics, allowing for non-intrusive internal imaging with enhanced detail. The system may be particularly beneficial for applications requiring stealth, as the radio signals may be less detectable than traditional acoustic signals, providing a measure of security and privacy.

Aspects of the disclosure are initially described in the context of communication systems. Aspects of the disclosure are additionally illustrated by and described with reference to example implementations. Aspects of the disclosure are further illustrated by and described with reference to a flowchart that relates to methods of using communication systems for enabling underwater radio frequency communication and imaging through surface electromagnetic waves.

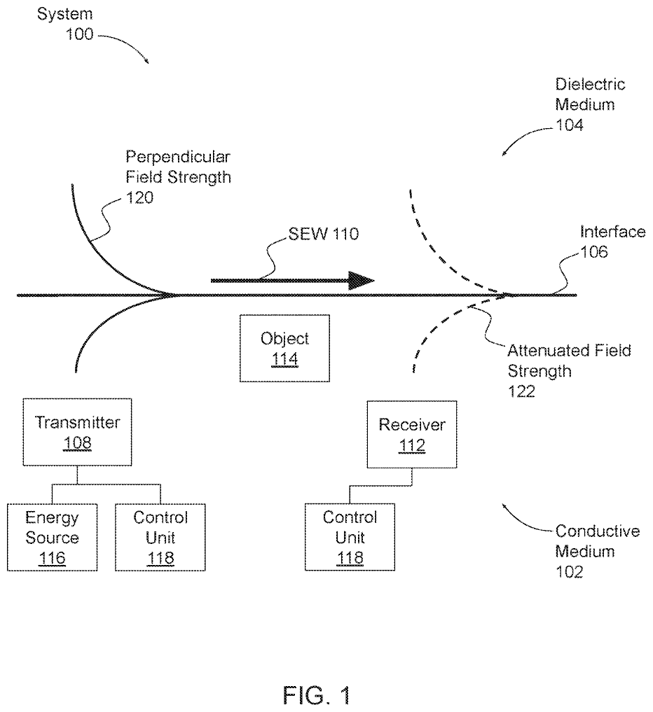

FIG. 1 illustrates a system 100 that demonstrates the concept of surface electromagnetic waves (SEWs), in accordance with one or more implementations. The system 100 may include a conductive medium 102, such as a body of water, organic tissue, a metallic plane, and/or other conductive media. Adjacent to the conductive medium 102, there may be a medium having a different conductivity 104, such as air and/or other dielectric media, which may interface with the conductive medium 102. The interface 106 between the conductive medium 102 and the other medium 104 may be where SEWs are generated and may propagate.

The system 100 may also include a transmitter 108, which may be positioned near the interface 106. The transmitter 108 may be positioned within the conductive medium 102 or within the dielectric medium 104. The transmitter 108 may be responsible for generating an electromagnetic field that may excite SEWs at the interface 106 of the conductive medium 102 and the dielectric medium 104. The excited SEWs may then travel along the interface 106, as indicated by the arrow of SEW 110, which may represent the direction of wave propagation.

To help visualize the phenomenon of SEWs, one may consider an analogy to ripples on a pond. When a stone is dropped into a still pond, ripples may form and spread out across the surface of the water. Similarly, the transmitter 108 may be thought of as the stone, and the SEWs may be akin to the ripples that spread along the conductive medium 102. Just as the ripples may move outward from the point of impact, SEWs may propagate along the interface 106, carrying energy with them.

The system 100 may further include a receiver 112, which may be positioned at a distance from the transmitter 108 along the interface 106. The receiver 112 may be positioned within the conductive medium 102 or within the dielectric medium 104. The receiver 112 may be configured to receive the SEWs after they have propagated along the interface 106. This may be analogous to placing one's hand in the water at a distance from where the stone was dropped, feeling the ripples as they pass by.

Additionally, the system 100 may include an object 114 positioned within the conductive medium 102 or within the dielectric medium 104, which may be representative of an obstacle that SEWs may encounter during propagation. The interaction of SEWs with the object 114 may lead to scattering of waves, similar to how water ripples may change direction or form patterns when they encounter a leaf or a rock in the pond.

The system 100 may include an energy source 116, such as a radio frequency generator, which may be connected to the transmitter 108. The energy source 116 may provide the necessary power for the transmitter 108 to generate the electromagnetic field that excites the SEWs. This may be thought of as the force with which the stone is thrown into the pond, affecting the size and strength of the resulting ripples.

In some implementations, the system 100 may include a control unit 118, which may be operatively coupled to the transmitter 108 and/or the receiver 112. The control unit 118 may be responsible for coordinating the generation and detection of SEWs, much like a person orchestrating the timing of stones being dropped into the pond to create a specific pattern of ripples.

From a more technical perspective, SEWs may be understood as a type of wave that propagates along the interface between two media with different conductive properties. In FIG. 1, the conductive medium 102 and the dielectric medium 104 may form such an interface (e.g., interface 106) where SEWs may be excited and propagate. The transmitter 108 may serve as a transducer that converts electrical signals from the energy source 116 into electromagnetic fields, which may then couple to the interface 106 and give rise to SEWs.

The propagation of SEWs along the interface 106 may be characterized by a wave vector that is parallel to the interface 106. This wave vector may be larger than the wave vector of free photons in the dielectric medium 104, which may result in a confinement of the electromagnetic field to the vicinity of the interface 106. The SEW's field strength may decay exponentially in the direction perpendicular to the interface 106, as illustrated by a field strength 120 extending into the dielectric medium 104 and the conductive medium 102. These field strengths may also decay as the SEW propagates along the interface 106, as illustrated by an attenuated field strength 122. The receiver 112 may be designed to couple to these confined, attenuated fields and receive the SEWs after they have propagated along the interface 106.

The excitation of SEWs by the transmitter 108 may involve the conversion of the electromagnetic energy into a surface-bound mode, which may be facilitated by the specific design of the transmitter 108. The transmitter 108 may be optimized to match the impedance of the SEWs to maximize energy transfer into the surface wave mode. The object 114 submerged within the conductive medium 102 may introduce perturbations in the SEWs, which may be detected by the receiver 112 and analyzed by the control unit 118 to infer properties of the object 114. Examples of such properties may include one or more of size, shape, location, material properties, and/or other properties.

The mathematical description of SEWs may be derived from Maxwell's equations, which govern the behavior of electromagnetic fields. The wave equation for TM-polarized SEWs may be reduced to a one-dimensional Schrodinger equation:

$$\frac{{d}^{2} ψ}{{dz}^{2}} + ( {k}^{2} - V ( z ) ) ψ = 0 \qquad ( EQN . 1 )$$

where ψ is the effective wave function introduced as E_{z}=ψ/\sqrt{∈}, and V(z) is the effective potential energy that guides the propagation of SEWs along the interface. The term k² may represent the total energy of the SEWs.

For TE-polarized SEWs, the wave equation may not depend on the gradient terms and may be expressed as:

$$\frac{{d}^{2} {E}_{z}}{{dz}^{2}} + {k}^{2} {E}_{z} = 0 \qquad ( EQN . 2 )$$

In the case of a sharp interface between two media with dielectric permittivities ∈₁ and ∈₂, the SEW wave vector for TM-polarized waves may be given by:

$${k}_{S E W} = \sqrt{\frac{{ω}^{2}}{{c}^{2}} \frac{{ϵ}_{1} {ϵ}_{2}}{{ϵ}_{1} + {ϵ}_{2}}} \qquad ( EQN . 3 )$$

where ω is the angular frequency of the SEWs, and c is the speed of light in vacuum.

The presence of dielectric permittivity gradients across the interface 106 may lead to additional terms in the effective potential V_{z}, which may result in the formation of a potential well that supports bound states of SEWs. These bound states may correspond to surface modes with long propagation lengths and may be excited by the transmitter 108 with appropriate phase matching.

The system 100 may thus utilize SEWs for various applications, including communication and sensing, by exploiting the unique properties of SEWs at the interface 106 between the conductive medium 102 and the dielectric medium 104. The control unit 118 may process the received signals to extract information about the propagation and interaction of SEWs with the environment and objects within it.

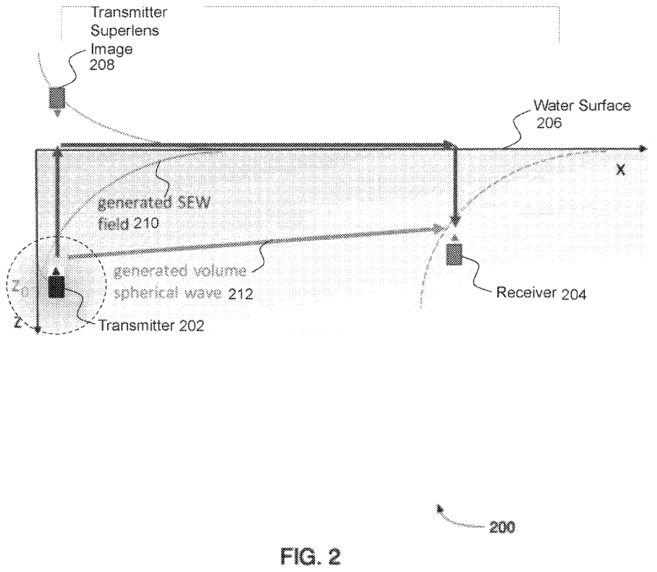

FIG. 2 shows underwater radio communication 200 which supports techniques for underwater radio frequency communication and imaging through surface electromagnetic waves in accordance with various aspects of the present disclosure. As depicted in FIG. 2, the underwater radio communication 200 may include one or more of a transmitter 202, a receiver 204, a water surface 206, a transmitter superlens image 208, a generated SEW field 210, a generated volume spherical wave 212, and/or other components.

The transmitter 202 may be configured to emit radio frequency signals for underwater communication. In some implementations, the transmitter 202 may be submerged in a body of water. The transmitter 202 may operate at specific frequencies suitable for underwater transmission. The transmitter 202 may be connected to an antenna system designed to couple with surface electromagnetic waves. The transmitter 202 may be part of a communication system that includes other devices such as receivers and processors.

The receiver 204 may be designed to detect and process signals emitted by the transmitter 202. In some implementations, the receiver 204 may be equipped with components sensitive to specific radio frequencies. The receiver 204 may convert the detected signals into a format that can be interpreted by connected devices. The receiver 204 may be positioned at a certain depth or distance from the transmitter 202 to effectively receive the signals.

The water surface 206 may serve as the boundary layer through which the SEW field 210 propagates. In some implementations, the water surface 206 may act as a medium that supports the movement of the SEW field 210. The water surface 206 may have properties that influence the propagation of the SEW field 210, such as salinity and temperature. The water surface 206 may interact with the SEW field 210 to allow the transmission of signals across the water-air interface.

The transmitter superlens image 208 may focus the SEW field 210 to facilitate the transmission of radio frequencies. The transmitter superlens image 208 may be positioned in a way that aligns with the direction of the SEW field 210 for effective focusing.

The generated SEW field 210 may propagate along the water surface 206, carrying the radio frequency signals. In some implementations, the SEW field 210 may be influenced by the characteristics of the water surface 206. The SEW field 210 may have a propagation length that determines the distance over which the signals can be transmitted. The SEW field 210 may interact with the superlens 208 to enhance the focus and direction of the transmitted signals.

The generated volume spherical wave 212 may represent a portion of the initial emission pattern of radio frequencies from the transmitter 202 before coupling with the SEW field 210. In some implementations, the volume spherical wave 212 may spread out in all directions from the source. The volume spherical wave 212 may have a decay rate that is determined by the properties of the surrounding water. The volume spherical wave 212 may transition into the SEW field 210 upon reaching the water surface 206.

In some implementations, the transmitter 202 may be positioned at a depth Z0 below the water surface 206, emitting a generated volume spherical wave 212 that propagates outward. The generated SEW field 210 may form at the water surface 206, extending horizontally along the surface. The superlens 208 may be located above the water surface 206, creating an image of the transmitter 202 to aid in focusing the SEW field 210.

In some implementations, the receiver 204 may be placed at a distance X from the transmitter 202, positioned to detect the SEW field 210 as it propagates along the water surface 206. The receiver 204 may capture the radio frequency signals carried by the SEW field 210, converting them into a format suitable for further processing. The arrangement of these components may enable effective underwater communication through the SEW channel.

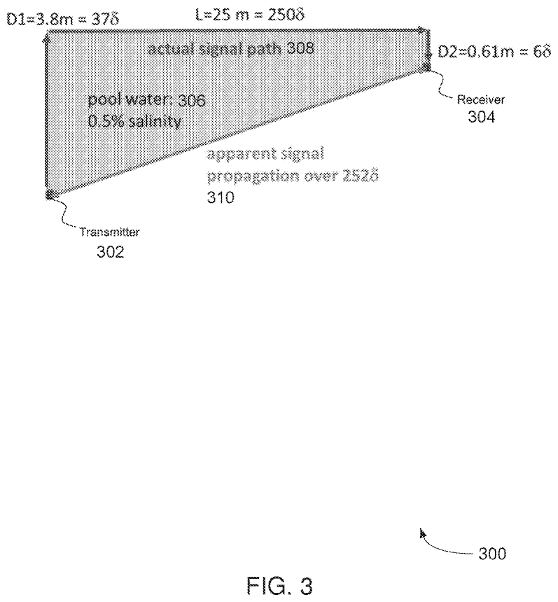

FIG. 3 shows a radio communication diagram 300 which supports techniques for enabling underwater radio frequency communication and imaging through surface electromagnetic waves in accordance with various aspects of the present disclosure. As depicted in FIG. 3, the radio communication diagram 300 may include one or more of a transmitter 302, a receiver 304, pool water 306, an actual signal path 308, apparent signal propagation 310, and/or other components.

The transmitter 302 may serve as the origin point for radio frequency signals in the underwater communication system. In some implementations, the transmitter 302 may be configured to generate radio frequency signals at specific frequencies suitable for underwater transmission. The transmitter 302 may be coupled with specialized antennas designed to excite surface electromagnetic waves for signal propagation. The transmitter 302 may be positioned at a certain depth within the pool water 306 to facilitate the coupling of radio signals to the surface electromagnetic wave mode.

The receiver 304 may function as the endpoint for receiving signals transmitted through the underwater communication system. In some implementations, the receiver 304 may be equipped with components sensitive to the specific frequencies emitted by the transmitter 302. The receiver 304 may be designed to detect the exponentially decaying electromagnetic fields as they emerge from the pool water 306. The receiver 304 may be placed at a similar depth as the transmitter 302 to align with the path of the surface electromagnetic waves.

The pool water 306 may act as the medium through which the radio frequency signals are propagated. In some implementations, the pool water 306 may possess certain conductive properties that affect the propagation of radio frequency signals. The pool water 306 may have a refractive index that influences the skin depth and propagation length of the surface electromagnetic waves. The pool water 306 may interact with the radio frequency signals, altering their path from a straight line to one that follows the surface electromagnetic wave mode.

The actual signal path 308 may represent the true path taken by radio frequency signals as they travel from the transmitter to the receiver. In some implementations, the actual signal path 308 may deviate from traditional expectations due to the unique propagation characteristics of surface electromagnetic waves. The actual signal path 308 may be determined by the interaction of the radio frequency signals with the pool water 306 and the surface electromagnetic wave mode.

The apparent signal propagation 310 may illustrate the perceived path of radio frequency signals if traditional propagation methods were assumed. In some implementations, the apparent signal propagation 310 may not accurately reflect the actual signal path 308 due to the influence of the pool water 306 on signal behavior. The apparent signal propagation 310 may be depicted to contrast with the actual signal path 308, highlighting the differences in signal travel due to the presence of surface electromagnetic waves.

In some implementations, the transmitter 302 may be positioned at a depth of 3.8 meters within the pool water 306, which may correspond to 37 skin depths (δ). The receiver 304 may be located at a depth of 0.61 meters, equivalent to 6 skin depths (δ). The actual signal path 308 may extend horizontally for a distance of 25 meters, or 250 skin depths (δ), along the surface of the pool water 306. The apparent signal propagation 310 may be perceived as a straight-line path through the bulk water, spanning 252 skin depths (δ).

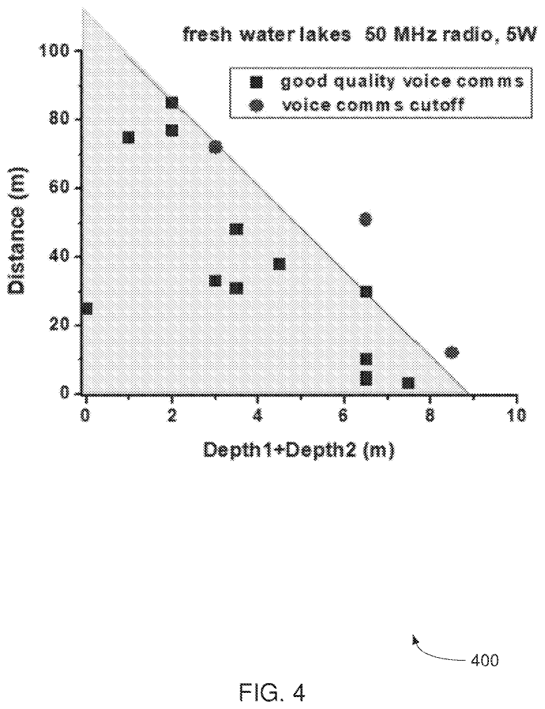

FIG. 4 shows a scatter plot 400 illustrating the relationship between communication distance and the sum of depths of two radios underwater in accordance with various aspects of the present disclosure. The scatter plot 400 may represent the results of underwater radio communication experiments performed at 50 MHz with a 5 W output power in freshwater lakes.

The x-axis of the scatter plot 400 may be labeled “Depth1+Depth2 (m)” and may represent the sum of the depths of the two radios underwater, measured in meters. The scale on the x-axis may range from 0 to 10 meters. The y-axis of the scatter plot 400 may be labeled “Distance (m)” and may represent the communication distance between the two radios, measured in meters. The scale on the y-axis may range from 0 to 100 meters.

The data points in the scatter plot 400 may be marked with two different symbols: squares and circles. The squares may represent instances of good quality voice communication, while the circles may indicate the cutoff points where voice communication was no longer achievable. The scatter plot 400 may exhibit a trend where good quality voice communication is achieved within a certain region, depicted as a grey triangle, and communication cutoff occurs outside this region.

The grey triangle in the scatter plot 400 may indicate the area where successful radio communication was achieved. The boundary of this triangle may suggest a linear relationship between the communication distance and the sum of the depths of the two radios. This linear dependence may be indicative of the SEW communication mechanism, as the slope of the boundary may align with the theoretical predictions for SEW propagation.

The scatter plot 400 may provide evidence that radio communication in freshwater lakes was successful for all data points located inside the grey triangle. The linear trend observed in the scatter plot 400 may support the hypothesis that SEW transmission enables efficient underwater radio communication over distances significantly greater than conventional limits.

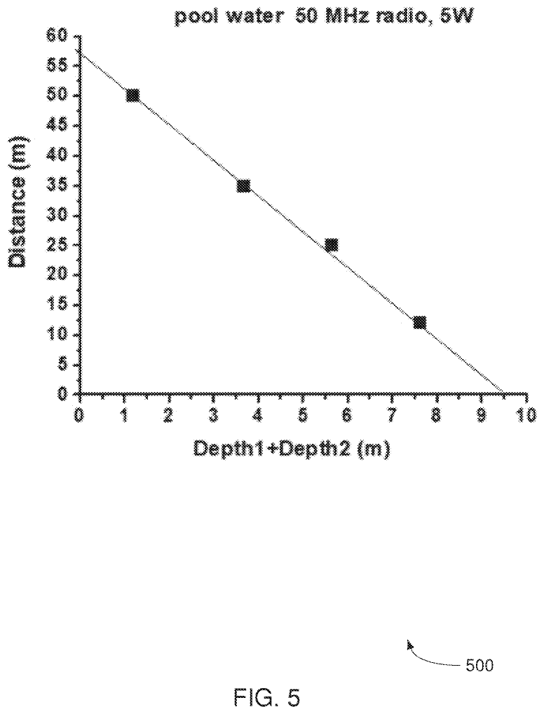

FIG. 5 shows a scatter plot 500 illustrating the relationship between communication distance and the sum of depths of two radios underwater in accordance with various aspects of the present disclosure. The line graph 500 may represent the results of underwater radio communication experiments performed using a 50 MHz radio with 5 W output power in pool water.

The x-axis of the scatter plot 500 may be labeled “Depth1+Depth2 (m)” and may represent the sum of the depths of the two radios underwater, measured in meters. The scale on the x-axis may range from 0 to 10 meters, with increments of 1 meter.

The y-axis of the scatter plot 500 may be labeled “Distance (m)” and may represent the communication distance between the two radios, measured in meters. The scale on the y-axis may range from 0 to 60 meters, with increments of 5 meters.

The data points in the scatter plot 500 may be marked with black squares and may exhibit a linear trend. The line connecting the data points may indicate a well-defined linear dependence between the communication distance and the sum of the depths of the two radios underwater. This linear trend may suggest that the communication distance decreases as the sum of the depths of the two radios increases.

The scatter plot 500 may provide evidence supporting the use of surface electromagnetic waves (SEW) for underwater radio communication. The observed linear dependence may indicate that the SEW communication mechanism is effective in enabling radio communication over distances of many hundreds of skin depths, even in the challenging underwater environment.

The scatter plot 500 may be interpreted to show that successful radio communication was achieved for all data points within the range of the graph. The slope of the line may be indicative of the efficiency of the SEW communication mechanism, with a steeper slope suggesting higher efficiency.

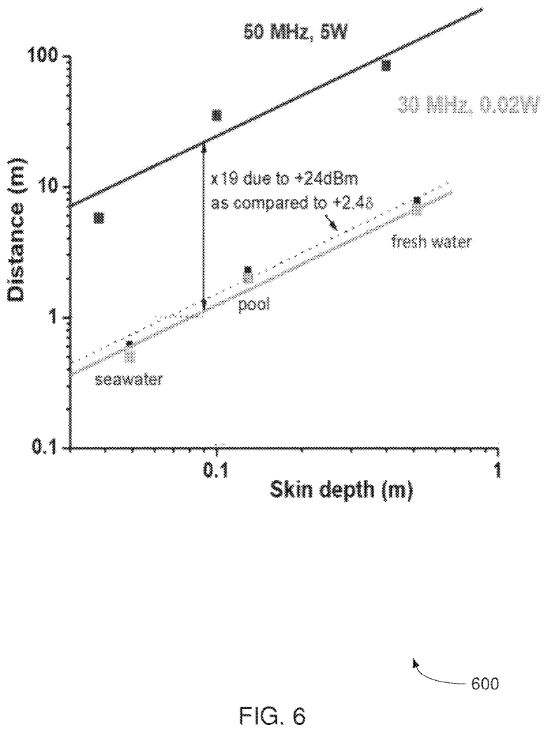

FIG. 6 shows a scatter plot 600 illustrating the power scaling of underwater radio communication experiments in accordance with various aspects of the present disclosure. The scatter plot 600 may represent the relationship between the communication distance and the skin depth for different water types and transmission powers.

The x-axis of the scatter plot 600 may be labeled “Skin depth (m)” and may represent the skin depth in meters. The scale of the x-axis may be logarithmic, ranging from 0.1 to 1 meter. The y-axis of the scatter plot 600 may be labeled “Distance (m)” and may represent the communication distance in meters. The scale of the y-axis may also be logarithmic, ranging from 0.1 to 100 meters.

The data points in the scatter plot 600 may be represented by black squares and may indicate the measured communication distances for different water types, including seawater, pool water, and fresh water. The black dashed line connecting the black squares may represent the expected increase in communication distance in a bulk communication channel, which may be proportional to 2.4 times the skin depth (2.4δ).

The solid black line in the scatter plot 600 may represent the measured communication distance for a transmission power of 5 W at 50 MHz. The grey line may represent the measured communication distance for a transmission power of 0.02 W at 30 MHz. The scatter plot 600 may indicate that an increase in transmit power by +24 dB (from 0.02 W to 5 W) may lead to a 19 times increase in the communication distance, as compared to the expected increase by just 2.48 in the bulk communication channel.

The scatter plot 600 may also include annotations indicating the different water types (seawater, pool, and fresh water) and the corresponding data points. The measured communication distance may still be proportional to the skin depth, as indicated by the alignment of the data points along the respective lines.

The scatter plot 600 may support the interpretation that upon reaching the water-air interface, the radio signal may propagate in a 2D fashion with the propagation distance roughly equal to 90 skin depth δ. This interpretation may match theoretical expectations and the directly measured profile of the surface electromagnetic wave near the water surface at 30 MHz.

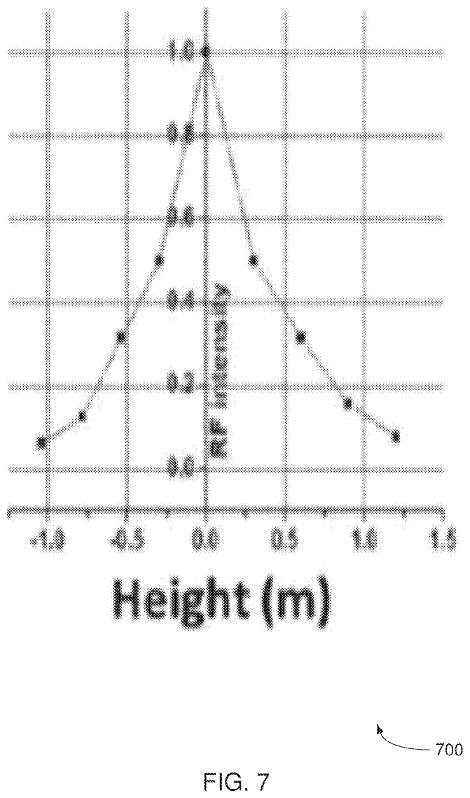

FIG. 7 shows a line graph 700 illustrating the measured profile of the surface electromagnetic wave near the water surface at 30 MHz in accordance with various aspects of the present disclosure. The line graph 700 may represent the relationship between the height (in meters) and the relative RF intensity of the surface electromagnetic wave.

The x-axis of the line graph 700 may be labeled “Height (m)” and may represent the height above and below the water surface, ranging from −1.0 meters to 1.5 meters. The y-axis may be labeled “RF intensity” and may represent the relative intensity of the radio frequency signal, ranging from 0.0 to 1.0.

The data points in the line graph 700 may be marked with small black squares and connected by a continuous line, indicating the trend of the RF intensity as a function of height. The graph may exhibit a peak at the height of 0 meters, where the RF intensity reaches its maximum value of 1.0. As the height increases or decreases from this point, the RF intensity may gradually decrease, forming a symmetrical curve around the peak.

The line graph 700 may demonstrate that the measured communication distance is proportional to the skin depth, matching theoretical expectations. The peak at 0 meters may indicate the highest concentration of the surface electromagnetic wave near the water surface, while the gradual decline on either side of the peak may suggest attenuation of the wave as it moves away from the surface.

This line graph 700 may provide valuable insights into the behavior of surface electromagnetic waves at 30 MHz, supporting the concept of using such waves for efficient radio signal transmission and high-resolution imaging through the water-air interface.

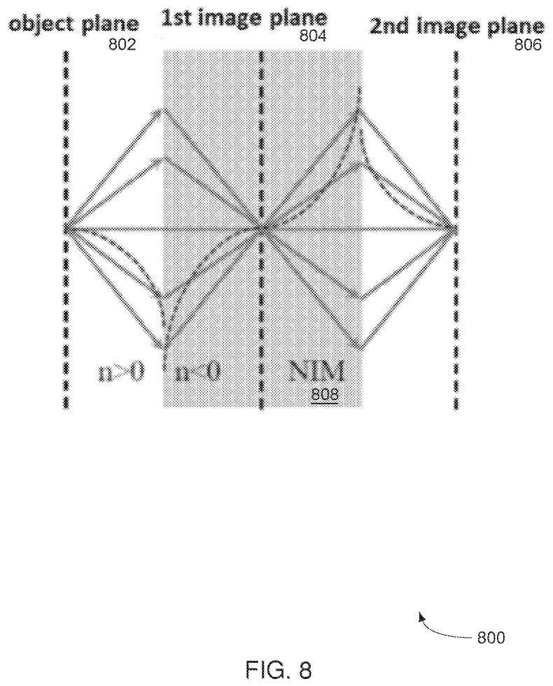

FIG. 8 shows superlens imaging transmission 800 which supports techniques for underwater radio frequency communication and imaging through surface electromagnetic waves in accordance with various aspects of the present disclosure. As depicted in FIG. 8, the superlens imaging transition 800 may include one or more of an object plane 802, a 1st image plane 804, a 2nd image plane 806, a negative index material (NIM) or its equivalent supporting SEW 808, and/or other components.

The object plane 802 may represent the initial location where the object of interest is positioned for imaging. In some implementations, the object plane 802 may be the starting point for the imaging process. The object plane 802 may be where the object's presence may influence the electromagnetic field to initiate the superlensing effect.

The 1st image plane 804 may provide a focal point for the first phase of image capture in the superlens imaging process. In some implementations, the 1st image plane 804 may capture an intermediate image that may not yet be magnified to its final form. The 1st image plane 804 may interact with the NIM (or its equivalent) 808 to transition the image towards the 2nd image plane 806.

The 2nd image plane 806 may serve as the final stage for capturing the magnified image of the object. In some implementations, the 2nd image plane 806 may hold the image that has been processed through the superlensing effect. The 2nd image plane 806 may receive the image from the 1st image plane 804 after it has been modified by the NIM 808.

The NIM 808 may function as a medium through which the superlensing effect is achieved. In some implementations, the NIM 808 may alter the path and characteristics of the electromagnetic waves carrying the image. The NIM 808 may work in conjunction with the object plane 802, the 1st image plane 804, and the 2nd image plane 806 to transition the image through the superlens imaging process.

In some implementations, the object plane 802 may be positioned on one side of the NIM 808, while the 1st image plane 804 may be located within the NIM 808. The 2nd image plane 806 may be situated on the opposite side of the NIM 808 from the object plane 802. The NIM 808 may be configured to interact with electromagnetic waves to create a super-resolution image at the 2nd image plane 806.

In some implementations, the NIM 808 may have a negative refractive index, which may cause the electromagnetic waves to bend in a manner that produces a focused image at the 1st image plane 804. The interaction between the NIM 808 and the electromagnetic waves may enhance the resolution of the image captured at the 2nd image plane 806.

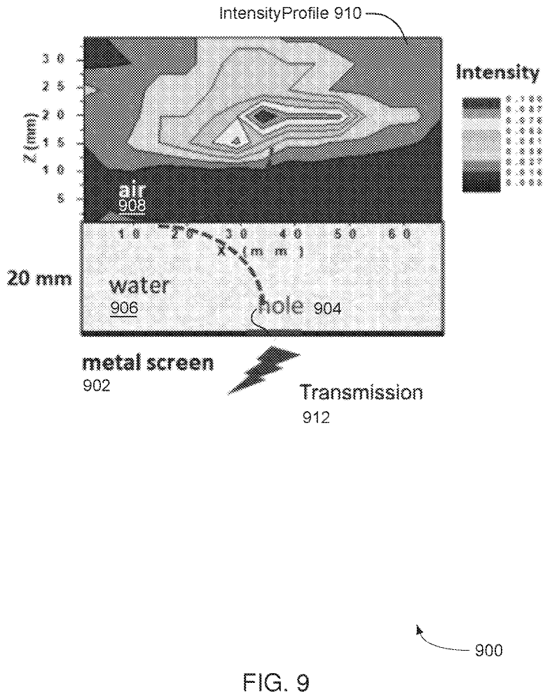

FIG. 9 shows underwater radio transmission 900 which supports techniques for enabling underwater radio frequency communication and imaging through surface electromagnetic waves in accordance with various aspects of the present disclosure. As depicted in FIG. 9, the underwater radio transmission 900 may include one or more of a metal screen 902, a hole 904, water 906, air 908, an intensity profile 910, transmission 912, and/or other components.

The metal screen 902 may serve as a physical structure within the underwater radio transmission 900. In some implementations, the metal screen 902 may be composed of a conductive material. The metal screen 902 may have a specific pattern or arrangement that influences the propagation of radio frequency signals. The metal screen 902 may interact with the water 906 to support the generation or manipulation of surface electromagnetic waves.

The hole 904 may allow passage of radio frequency signals in the underwater radio transmission 900. In some implementations, the hole 904 may be of a size that is determined based on the wavelength of the radio frequency signals. The hole 904 may be strategically positioned within the metal screen 902 to facilitate the desired transmission 912 of radio frequency signals. The hole 904 may be one of multiple apertures within the metal screen 902 that collectively contribute to the pattern of signal propagation.

The water 906 may act as a medium for the propagation of surface electromagnetic waves in the underwater radio transmission 900. In some implementations, the water 906 may have properties such as salinity and temperature that affect the behavior of the surface electromagnetic waves. The water 906 may interact with the air 908 to create an interface where the surface electromagnetic waves can propagate. The water 906 may be a variable component, as different bodies of water may have different characteristics that influence the underwater radio transmission 900.

The air 908 may provide a contrasting medium above the water 906 in the underwater radio transmission 900. In some implementations, the air 908 may have a different refractive index than the water 906, which may affect the transmission 912 of radio frequency signals. The air 908 may be part of the environment where the intensity profile 910 of the radio frequency signals is measured or observed. The air 908 may be considered when determining the conditions for optimal signal transmission in the underwater radio transmission 900.

The intensity profile 910 may represent the distribution of radio frequency signal strength in the underwater radio transmission 900. In some implementations, the intensity profile 910 may be used to analyze the effectiveness of the signal transmission 912 through the water 906. The intensity profile 910 may vary depending on factors such as the distance from the metal screen 902 and the properties of the water 906. The intensity profile 910 may be visualized using various methods to assess the pattern and strength of the radio frequency signals.

The transmission 912 may carry the radio frequency signals within the underwater radio transmission 900. In some implementations, the transmission 912 may be influenced by the design of the metal screen 902 and the presence of the hole 904. The transmission 912 may be directed towards a receiver or sensor that is part of the underwater radio transmission 900. The transmission 912 may be a key factor in the performance of the system for communication and imaging purposes.

In some implementations, the metal screen 902 may be positioned below the water 906, with the hole 904 located centrally within the metal screen 902. The water 906 may form a 20 mm thick layer above the metal screen 902, creating an interface with the air 908 above it. The intensity profile 910 may be measured in the air 908 above the water 906, indicating the distribution of the radio frequency signal strength.

In some implementations, the transmission 912 may occur through the hole 904 in the metal screen 902, propagating through the water 906 and into the air 908. The interaction between the water 906 and the air 908 may support the generation of surface electromagnetic waves, which may be visualized in the intensity profile 910. The arrangement of these components may facilitate the desired transmission 912 of radio frequency signals for communication and imaging purposes.

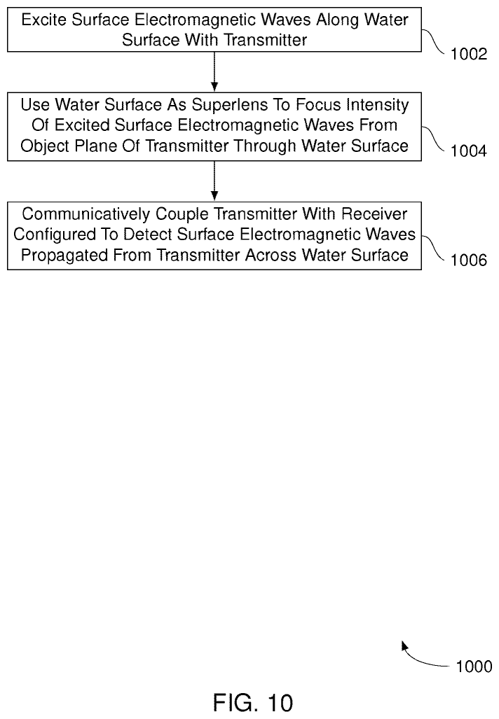

FIG. 10 shows a flowchart illustrating a method 1000 of using communication systems for enabling underwater radio frequency communication and imaging through surface electromagnetic waves in accordance with various aspects of the present disclosure.

At 1002, the method 1000 may include exciting surface electromagnetic waves along a water surface with a transmitter. The operations of 1002 may be performed in accordance with examples as disclosed herein. In some examples, aspects of the operations of 1002 may be performed by a transmitter 602 as described with reference to FIG. 6.

At 1004, the method 1000 may include using the water surface as a superlens to focus an intensity of the excited surface electromagnetic waves from an object plane of the transmitter through the water surface. The operations of 1004 may be performed in accordance with examples as disclosed herein. In some examples, aspects of the operations of 1004 may be performed by a water surface 606 and a superlens 610 as described with reference to FIG. 6.

At 1006, the method 1000 may include communicatively coupling the transmitter with a receiver configured to detect the surface electromagnetic waves propagated from the transmitter across the water surface. The operations of 1006 may be performed in accordance with examples as disclosed herein. In some examples, aspects of the operations of 1006 may be performed by a transmitter 602 and a receiver 604 as described with reference to FIG. 6.

It should be noted that the methods described herein describe possible implementations, and that the operations and the steps may be rearranged or otherwise modified and that other implementations are possible. Furthermore, aspects from two or more of the methods may be combined.

Aspect 1: A communication system for underwater use, comprising: a transmitter configured to excite surface electromagnetic waves along a water surface; wherein the water surface is utilized as a superlens to focus an intensity of the excited surface electromagnetic waves from an object plane of the transmitter through the water surface; and wherein the transmitter is further configured to communicatively couple with a receiver configured to detect the surface electromagnetic waves propagated from the transmitter across the water surface.

Aspect 2: The communication system of aspect 1, wherein the transmitter includes a transmitter antenna configured to match a field configuration of the surface electromagnetic waves for excitation along the water surface, ensuring efficient coupling and propagation of the waves for underwater communication.

Aspect 3: The communication system of any of aspects 1 through 2, wherein the transmitter antenna is configured to provide directional intensity for the excitation of the surface electromagnetic waves propagated from a transmitter, allowing for targeted communication and reduced interference.

Aspect 4: The communication system of any of aspects 1 through 3, wherein the transmitter antenna includes an array of antennas, which can be utilized to form directional beams and enhance the control over the propagation of the surface electromagnetic waves.

Aspect 5: The communication system of any of aspects 1 through 4, further comprising a receiver antenna configured to match a field configuration of the surface electromagnetic waves for detection along the water surface, enabling the receiver to effectively capture the transmitted signals.

Aspect 6: The communication system of any of aspects 1 through 5, wherein the receiver antenna array is configured to provide directional sensitivity for the detection of the surface electromagnetic waves propagated from one or more transmitters, improving the accuracy and quality of the received signals.

Aspect 7: The communication system of any of aspects 1 through 6, wherein the receiver antenna includes an array of antennas, which can be arranged to optimize the reception of the surface electromagnetic waves and enhance the system's overall performance.

Aspect 8: The communication system of any of aspects 1 through 7, wherein the transmitter is configured to operate at a frequency range that allows for communication over distances of 100 or more skin depths in fresh water, significantly extending the operational range of underwater radio communication.

Aspect 9: The communication system of any of aspects 1 through 8, wherein the receiver is configured to detect subwavelength super-resolution images of an object located below the water surface by analyzing the intensity of the received surface electromagnetic waves, providing high-resolution imaging capabilities.

Aspect 10: The communication system of any of aspects 1 through 9, further comprising a protective enclosure for one or both of the transmitter and the receiver, the protective enclosure being configured to prevent short-circuiting when submerged in water, ensuring the durability and reliability of the system components.

Aspect 11: The communication system of any of aspects 1 through 10, wherein the water surface acts as a superlens to enhance the transmission of the surface electromagnetic waves from the object plane to the receiver, leveraging the unique properties of water to improve signal clarity and strength.

Aspect 12: The communication system of any of aspects 1 through 11, wherein the transmitter is configured to operate in seawater, enhancing the intensity of the surface electromagnetic waves for robust transmission, making the system suitable for a variety of aquatic environments.

Aspect 13: The communication system of any of aspects 1 through 12, wherein the receiver is configured to detect changes in the intensity of the surface electromagnetic waves in response to an object interacting with a metal screen submerged in a pool, enabling the system to be used for a range of detection and imaging applications.

Aspect 14: A method for communicating underwater, comprising: exciting surface electromagnetic waves along a water surface with a transmitter; using the water surface as a superlens to focus an intensity of the excited surface electromagnetic waves from an object plane of the transmitter through the water surface; and communicatively coupling the transmitter with a receiver configured to detect the surface electromagnetic waves propagated from the transmitter across the water surface.

Aspect 15: An apparatus for a communication system, comprising at least one means for performing a method of any of aspect 14.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A communication system for underwater use, comprising:
a transmitter configured to excite surface electromagnetic waves along a water surface;
the water surface is used as a superlens to focus an intensity of the excited surface electromagnetic waves from an object plane of the transmitter through the water surface; and
the transmitter is further configured to communicatively couple with a receiver configured to detect the surface electromagnetic waves propagated from the transmitter across the water surface.

2. The communication system of claim 1, wherein the transmitter includes a transmitter antenna configured to match a field configuration of the surface electromagnetic waves for excitation along the water surface.

3. The communication system of claim 2, wherein the transmitter antenna is configured to provide directional intensity for the excitation of the surface electromagnetic waves propagated from a transmitter.

4. The communication system of claim 2, wherein the transmitter antenna includes an array of antennas.

5. The communication system of claim 1, further comprising a receiver antenna configured to match a field configuration of the surface electromagnetic waves for detection along the water surface.

6. The communication system of claim 5, wherein the receiver antenna array is configured to provide directional sensitivity for the detection of the surface electromagnetic waves propagated from one or more transmitters.

7. The communication system of claim 5, wherein the receiver antenna includes an array of antennas.

8. The communication system of claim 1, wherein the transmitter is configured to operate at a frequency range that allows for communication over distances of 100 or more skin depths in fresh water.

9. The communication system of claim 1, wherein the receiver is configured to detect subwavelength super-resolution images of an object located below the water surface by analyzing the intensity of the received surface electromagnetic waves.

10. The communication system of claim 1, further comprising a protective enclosure for one or both of the transmitter and the receiver, the protective enclosure being configured prevent short-circuiting when submerged in water.

11. The communication system of claim 1, wherein the water surface acts as a superlens to enhance the transmission of the surface electromagnetic waves from the object plane to the receiver.

12. The communication system of claim 1, wherein the transmitter is configured to operate in seawater, enhancing the intensity of the surface electromagnetic waves for robust transmission.

13. The communication system of claim 1, wherein the receiver is configured to detect changes in the intensity of the surface electromagnetic waves in response to an object interacting with a metal screen submerged in a pool.

14. A method for communicating underwater, comprising:
exciting surface electromagnetic waves along a water surface with a transmitter;
using the water surface as a superlens to focus an intensity of the excited surface electromagnetic waves from an object plane of the transmitter through the water surface; and
communicatively coupling the transmitter with a receiver configured to detect the surface electromagnetic waves propagated from the transmitter across the water surface.

15. The method of claim 14, wherein exciting surface electromagnetic waves includes utilizing a transmitter antenna configured to match a field configuration of the surface electromagnetic waves for excitation along the water surface.

16. The method of claim 14, wherein the transmitter antenna is configured to provide directional intensity for the excitation of the surface electromagnetic waves propagated from the transmitter.

17. The method of claim 14, wherein the transmitter antenna comprises an array of antennas.

18. The method of claim 14, further comprising detecting the surface electromagnetic waves with a receiver antenna configured to match a field configuration of the surface electromagnetic waves for detection along the water surface.

19. The method of claim 14, wherein the receiver antenna is configured to provide directional sensitivity for the detection of the surface electromagnetic waves propagated from one or more transmitters.

20. The method of claim 14, wherein the receiver antenna comprises an array of antennas.
